(19) United States
(12) Patent Application Publication
(10) Pub. No.: US 2016/0189193 A1
(43) Pub. Date: Jun. 30, 2016

(54) SYSTEM AND METHOD FOR AUTHORIZING CUSTOMIZED CONTENT

(71) Applicant: Meridian Enterprises Corporation, Hazelwood, MO (US)

(72) Inventors: Samuel G. Toumayan, St. Louis, MO (US); John L. McMullin, III, St. Louis, MO (US); Paul Lewis, Dardenne Prairie, MO (US); Aaron Eversoll, O Fallon, MO (US); Greg Toumayan, Hazelwood, MO (US)

(21) Appl. No.: 15/062,393

(22) Filed: Mar. 7, 2016

Related U.S. Application Data
(63) Continuation-in-part of application No. 12/729,507, filed on Mar. 23, 2010, now Pat. No. 9,280,783.

(51) Int. Cl. G06Q 30/02; G01S 19/13; H04W 64/00; G06Q 30/06

(52) U.S. Cl. CPC G06Q 30/0225; G06Q 30/0609; G06Q 30/0239; G06Q 30/0621; G06Q 30/0641; G01S 19/13; H04W 64/00

(57) ABSTRACT

A system and method for providing customized on-line content is disclosed. The system uses customer's computer, location, URL, IP address, email domain, embedded promotion code, or other predetermined criteria to provide special content including product offerings and pricing for a particular class or subclass of customers. If an unauthorized user attempts to access the system, a series of screens containing non-customized content is presented to the intruder so as not to alert the intruder that he or she has reached the restricted content. Based on the authentication information, automated manufacturing processes and equipment may be utilized to produce the customized products.

This application is a continuation-in-part of U.S. patent application Ser. No. 12/729,507 filed Mar. 23, 2010, the entire disclosure of which is hereby incorporated by reference.

### TECHNICAL FIELD OF THE DISCLOSURE

The present disclosure relates to electronic commerce and, more specifically, to systems and methods for customizing a shopping interface for a particular customer or class of customers without the need for the customer to enter information into the interface. The present disclosure also relates to automated and/or custom manufacturing of products for a particular customer or class of customers.

### BACKGROUND OF THE INVENTION

In recent years, the prevalence of online shopping websites has increased dramatically. Many manufacturers and resellers which operate such websites occasionally offer discounts directed to a certain class of customers. However, the manufacturers may not want their other customers or competitors to become aware of the special discounts being offered. It is therefore desirable to restrict access to the special pricing information to those customers that have been selected to receive the discount.

Known methods for determining which customers are accessing a website generally require the customer to manually input a username and/or password. If the username and password are compromised, unauthorized individuals may gain access to the sensitive pricing information. Other methods, such as the use of browser “cookies,” require the user to enable cookies on their browser, a step many users are unwilling or unable take, as cookies are typically considered a privacy risk. Still other security measures may be employed, such as the use of digital certificates or other encryption keys, however these measures may be difficult or frustrating for users to implement, thereby discouraging the use of an online shopping website.

The manufacturers and resellers may also have problems determining the specific product customizations that are appropriate for a given class of customers and, more particularly, conveying such information to the manufacturing facility or distribution center for each unit of product purchased. There is therefore a need for systems and methods which provide a more secure, yet convenient, shopping experience for the user and a more streamlined manufacturing and/or distribution process for the provider. The present application fills this need.

### SUMMARY

According to one aspect, a system for providing customized online shopping is disclosed, comprising a web server for communicating with an external client computer, the web server containing computer readable code for presenting a customized online shopping interface; wherein the computer readable code is configured to generate first product information for display on the external client computer upon the authentication of a user; wherein the authentication is based on at least one of a referring IP address, a referring URL, an email domain and an embedded promotion code contained in a request sent from the external client computer to the web server; and wherein the computer readable code is configured to generate second product information for display on the external client computer when an unauthorized user is detected.

According to another aspect, a method for providing customized online shopping is disclosed, comprising the steps of receiving an HTTP request, the HTTP request containing a referring IP address, a referring URL, an email domain and an embedded promotion code; evaluating at least one of the referring IP address, the referring URL, the email domain and the embedded promotion code to determine if a user is authorized for access to a customized online shopping interface; presenting the user with first product information based on at least one of the referring IP address, the referring URL, the email domain and the embedded promotion code if the user is determined to be authorized for access; and presenting the user with second product information if the evaluating step determines that the user is not authorized; wherein an authorized user is not required to manually enter any identification information to gain access to the customized online shopping interface.

According to yet another aspect, a device is disclosed, comprising a computer readable medium, the computer readable medium containing computer executable code for generating a customized online shopping interface; wherein the computer executable code is configured to generate the customized online shopping interface according to a method comprising the steps of receiving an HTTP request, the HTTP request containing a referring IP address, a referring URL, an email domain and an embedded promotion code; evaluating at least one of the referring IP address, the referring URL, the email domain and the embedded promotion code to determine if a user is authorized for access to the customized online shopping interface; presenting first product information to the user based on at least one of the referring IP address, the referring URL, the email domain and the embedded promotion code if the user is determined to be authorized for access; and presenting the user with second product information if the evaluating step determines that the user is not authorized; wherein an authorized user is not required to manually enter any identification information to gain access to the customized online shopping interface.

In yet another aspect, a method is disclosed that includes using a server computer having a processor to receive an HTTP request from a remote client computer over a network, the HTTP request including a request header containing a referring IP address; determining the present location of the remote client computer using the server computer or the remote client computer; determining if a user is within a geographical area associated with a first product information using a geolocation module in the server computer and/or the remote client computer; determining if the referring IP address is an authorized IP address by comparing at least a portion of the referring IP address to one or more referring IP address rules associated with the first product information using the server computer and/or the remote client computer; determining the user is authorized to access the first product information when the user is within the geographical area associated with the first product information, and the referring IP address is an authorized IP address; transmitting the first product information to the remote client computer using the network when the user is authorized to access the first product information; determining the user is not authorized to access the first product information when the user is not within the geographical area associated with the first product information, or the referring IP address is not an authorized IP address; and transmitting a second product information to the remote client computer using the network when the user is not authorized to access the first product information.

### BRIEF DESCRIPTION OF THE DRAWINGS

FIG. 1 is a schematic block diagram of a system for providing customized on-line content according to one embodiment of the present disclosure.

FIG. 2 is a schematic flow diagram of a method for providing customized content according to one embodiment of the present disclosure.

FIG. 3 is a schematic diagram illustrating additional details on a system like the system of FIG. 1 that uses geolocation systems for providing customized content to authorized users.

FIG. 4 is a diagram illustrating methods of defining regions for authorizing customized content.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

The present disclosure relates to the use of a referring Uniform Resource Locator (URL), a referring Internet Protocol (IP) address, an email domain, an embedded promotion code, a computer physical location, or other predetermined criteria to recognize and customize the product data and/or shopping interface for a particular customer or class of customers without the customer entering any information into the interface. The system allows a company to offer product discounts or selective pricing discounts to certain classes of retail customers on a website without alerting other classes of customers (i.e., business-to-business or wholesale buyers) of the special discounts being offered. Other customizations may be implemented based on the user profile including, but not limited to, specific model availability, overall interface look and feel, and special terms and conditions related to the sale. No browser cookies or other intrusive measures are required to identify the user's status for purposes of receiving discounts or customized product offerings.

If an unauthorized user is detected, the system will report and track the intrusion, but will go ahead and present a normal shopping interface with non-customized products and/or pricing. This prevents unauthorized users from being alerted that they are being shut out of a “protected” portion of the system, which might otherwise encourage them to try harder to gain access. The system tracks and reports all authorized and unauthorized access, including the reason that users were denied or allowed access.

The disclosed embodiments eliminate the need for ongoing maintenance of data related to individual employees. When an employee leaves a company, there is no need to remove the employee's name from a database in the online shopping system if the discount for that company is based on employee status. For example, the employee would no longer be accessing the shopping site from his or her work computer and therefore the referring IP address or URL would no longer match that of the employer web server.

The disclosed system also eliminates the need for Payment Card Industry (PCI) standards compliance in cases where payment for the purchased items is not made using the user's own credit card (e.g., when the employer is billed directly for the employee user's purchases).

The system also allows customized products and/or pricing to be set up in a hierarchical fashion, with various subsets. For example, the subsets can be based on classes of employees in a company or brands within a store. The Manufacturer's Suggested Retail Price (MSRP) of a product can be changed, whereby the discounted pricing for all of the various customized interfaces will automatically be updated.

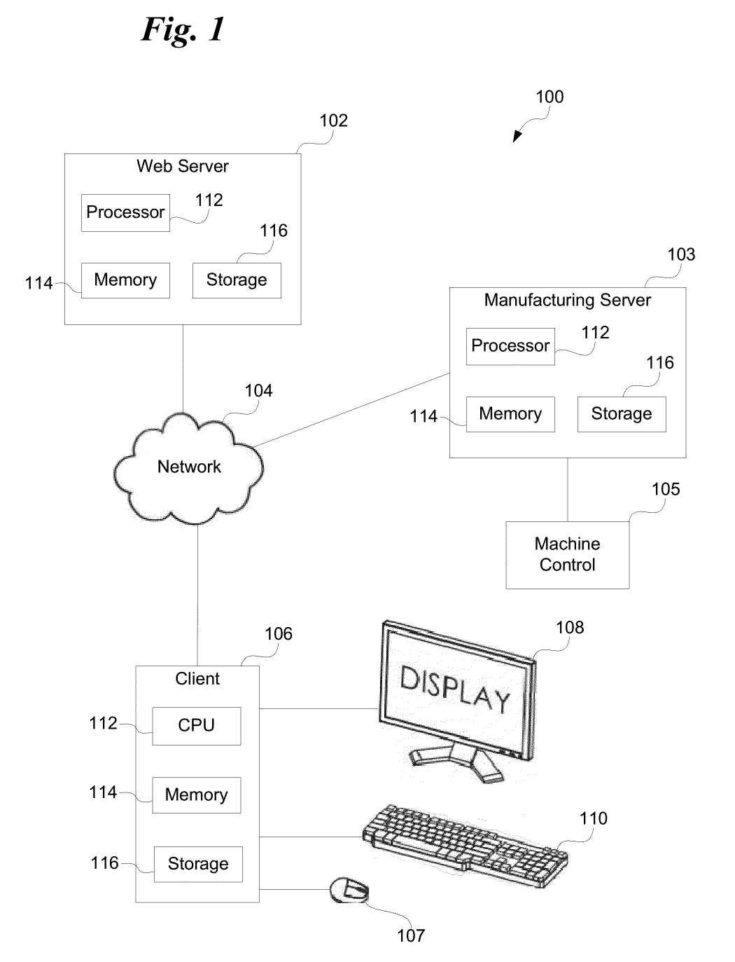

FIG. 1 shows a schematic block diagram of a system according to one embodiment of the present disclosure. System 100 includes web server 102, manufacturing server 103, network 104, machine control 105, client 106, display 108, and user input devices such as keyboard 110 and mouse 107. These devices are coupled to the client 106 to access customized product information from the server computer 102 and display the information for the user on display 108.

The web server 102 and manufacturing server 103 may be implemented on a rack-mountable or blade server, a personal computer, a workstation computer, a laptop computer, a palmtop computer, or the like. It will be apparent to those of ordinary skill in the art that other computer system architectures may also be employed.

In general, each of the web server 102 and manufacturing server 103 comprise a bus for communicating information, a processor 112 coupled with the bus for processing information and a memory 114 coupled to the bus for storing information and instructions for the processor 112. A mass storage interface for communicating with a data storage device 116 containing digital information may also be included in each of the web server 102 and manufacturing server 103 as well as a network interface for communicating with a the network 104.

The mass storage interface may allow the processors 112 access to the digital information contained within the storage devices 116 via the bus. The mass storage interface may be a universal serial bus (USB) interface, an integrated drive electronics (IDE) interface, a serial advanced technology attachment (SATA) interface or the like, coupled to the bus for transferring information and instructions. The data storage device 116 may be a conventional hard disk drive, a floppy disk drive, a flash device (such as a jump drive or SD card), an optical drive such as a compact disc (CD) drive, digital versatile disc (DVD) drive, HD DVD drive BLU-RAY disc drive, or another magnetic, solid state, or optical data storage device, along with the associated medium (a floppy disk, a CD-ROM, a DVD, etc).

Client 106 may be implemented using any of the computer architectures described above in relation to web server 102 and manufacturing server 103. Client 106 may further be implemented using a wireless terminal having computing capabilities, such as a mobile phone having a Windows CE or Palm operating system, an iPhone™ or the like. Client 106 may also comprise a processor 112, memory 114, mass storage interface, bus, network interface and storage devices 116 as described hereinabove in relation to web server 102 and manufacturing server 103.

The display 108 is coupled to the communication bus of client 106 for displaying information for a user and the input devices 110, 107 are coupled to the bus for communicating information and command selections to the processor 112. The display 108 may comprise a liquid crystal display (LCD), a cathode ray tube (CRT), a plasma monitor, an organic light emitting diode (OLED) display, or other suitable display device. Using the display 108, the user is able to view information regarding various goods for sale with customized pricing for the class of customers to which the user belongs.

In general, the processor 112 retrieves processing instructions and data from the data storage device 116 using the mass storage interface and downloads this information into random access memory for execution. The processor 112 then executes an instruction stream from random access memory or read-only memory. Command selections and information that is input using input devices 110, 107 are used to direct the flow of instructions executed by the processor 112. The results of this processing execution are then displayed on display device 108. Web server 102, manufacturing server 103, and client 106 are able to communicate via network 104.

Manufacturing server 103 may be operatively connected to machine control 105 to enable the automated manufacturing or distribution of particular physical goods. Machine control 105 may comprise various types of manufacturing control equipment such as programmable logic controllers (PLCs), Supervisory Control and Data Acquisition (SCADA), Remote Terminal Units (RTUs), and other machine controls known in the art. Machine control 105 is operatively connected to the manufacturing and/or distribution equipment (not shown) which physically creates, assembles, or retrieves the customized goods in response to orders placed by the user via client 106. It shall be appreciated by those of ordinary skill in the art that machine control 105 may be implemented as an integral component within the manufacturing server 103 or as a separate unit.

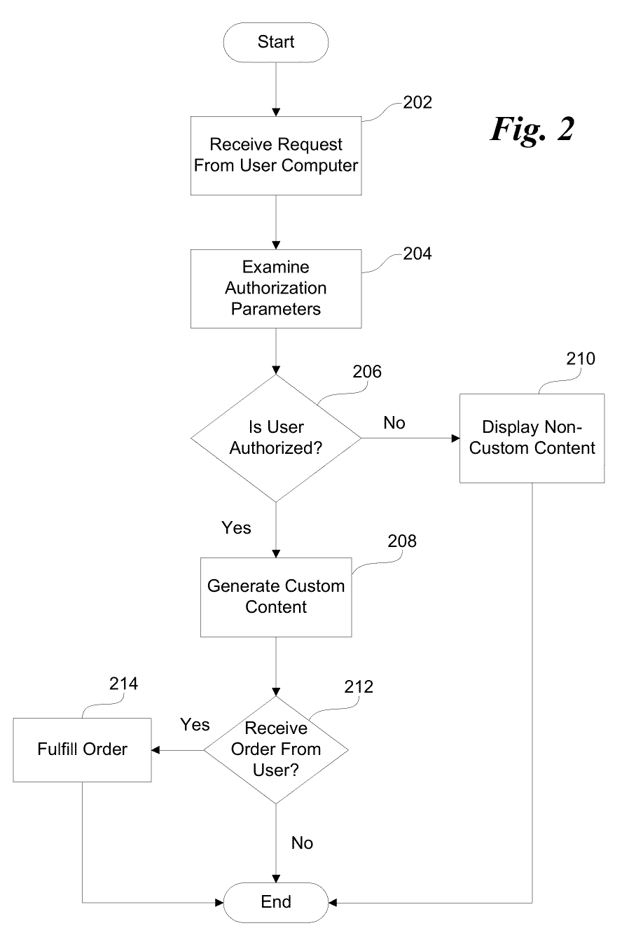

FIG. 2 illustrates one example of a process for customizing content displayed to authorized users that is different from content displayed to unauthorized uses. For example, the customized content may include an online shopping interface, customized product information, or other content. The process starts at 202 when the web server 102 receives a request from the client 106. The request may be sent when the user enters a URL link, also known as a “web address,” into a web browser program on client 106. The URL link contains the address of a customized webpage which may include special pricing, customized pages, and/or customized product information based on a particular class of customers. In certain embodiments, the URL link may be provided to the user as a hyperlink within an email or on an intranet website, wherein the user simply clicks on the URL link as opposed to manually typing the URL link into the web browser address bar. The request is typically in the form of a Hypertext Transfer Protocol (HTTP) request, but other types of requests containing an embedded URL link are contemplated to be within the scope of the disclosure.

Once the web server 102 has received the client request, it examines the value of various authorization parameters at 204. These authorization parameter values may be included in the HTTP request sent from the client, or may be determined by server 102. For example, the server 102 may examine the information contained in the HTTP request headers including the referring Internet Protocol (IP) address and the referring URL. The server may also determine the location of the client computer 106 such as by examining location parameter values in the HTTP request sent by client computer 106, or by determining the location of client computer 106 using geolocation software.

The web server 102 executes software to determine whether the user is authorized to view the desired pricing and product information. In one embodiment, the user is authorized based on at least a portion of the referring IP address contained in the request header. That is, only users whose requests originate from a particular IP address may be allowed access to the content. In another example, only users whose requests originate from a particular range of IP addresses may be allowed access. In yet another example, an IP address rule is configured to match (that is to say “authorize”) requests where specific octets or sections of the IP address include specific arrangements of values. In other embodiments, the referring URL is used to authenticate the user.

In still further embodiments, a combination referring IP address, and/or referring URL may be used to authenticate the user. Other criteria may be used to automatically authenticate the user including, but not limited to, the geolocation of the user client computer 106 or the name or network id of the user. For example, geolocation may be achieved by any suitable means such as automatically looking up the referring IP address in a WHOIS database to determine the physical location of the registrant, by a geolocation module and/or a receiver in client computer 106 configured to interact with a positioning or geolocation system using Global Positioning Satellite (GPS) or cellular positioning data or signals. Additionally, the user's network id or name may be contained in the transmitted HTTP request if the user's employer or network administrator has granted access to the its internal network identification by exposing its Lightweight Directory Access Protocol (LDAP) library to the web server 102.

Still other types of identification may be used to authenticate the user. For example, the email domain of the user may be extracted from the HTTP request headers. The email domain is typically listed in the HTTP “From” request header, although the present disclosure contemplates that other request header fields may be used which contain the email domain information. In still other embodiments, an embedded coupon code contained in the HTTP header information may be extracted and used to authenticate the user. For example, the coupon code can be contained within the referring URL or other header information to identify which types of discounts or customized product offerings the user is qualified to receive.

At 206, the web server 102 evaluates the authentication information of the user from 204. If the web server 102 determines that the user is in the class of customers who are authorized to view the customized information, it generates the custom content for the particular customer class at 208. The product information is then displayed for the user on display 108 in an HTML web page or other appropriate format. In this way, the user is able to view customized products and/or special pricing without having to first enter a username and/or password. For example, if all of the employees who work for a certain company are to be given a particular discount on products, or to be offered specific products, the IP address of the company's main internet router may be registered with the vendor offering the discount. Whenever an employee accesses a designated vendor web page using a computer on the employer's internal network (with the employee's computer sending a request to the vendor web server 102 ), the employee will have the instant ability to view the customized products and/or pricing without having to enter a login name or password. At the same time, the vendor is protected from unauthorized users gaining access to the restricted pricing and product information.

In addition to price and model, the offered products may contain further customizations based on the received user IP address, referring URL, email domain, geolocation of the client computer, or embedded coupon code. Certain products, such as computers or other electronics, may be built to the customer's specifications based on a previous arrangement between the employer company and the product vendor. For example, a desktop computer manufacturer may agree to use parts from a certain supplier whenever employees of the supplier order computers from that manufacturer. Other products, such as clothing, may be manufactured with a specific company logo for any employee of that company who placed an order for the clothing. In addition, the terms and conditions for sale, including return policies or shipping and handling methods, may be customized based on the identity or class profile of the user.

The overall look and feel of the shopping interface screens presented to the user may also be customized based on the user profile. For example, if the products being offered are automotive parts, the background colors and on-screen controls may be tailored to appeal to automotive enthusiasts. As another example, a company logo may be displayed on the shopping interface.

The above-mentioned customizations may be implemented as a hierarchy, with different levels and sublevels based on the user profile. For example, a first level of customization may be implemented for all employees of a certain employer, with further customizations implemented depending on the department or seniority level of each employee. In other embodiments, a certain level of discount may be offered for all products being offered through the online shopping interface, with separate additional discounts applied to various products depending on the manufacturer of each product.

If the web server 102 determines that the user does not have permission to access the custom product offerings at 206, the process proceeds to step 210 where non-custom catalog content is generated, routed to the client 106, and displayed to the user with standard pricing and product offerings. Because the unauthorized user sees a seemingly normal shopping screen with standard pricing, as opposed to a warning or other rejection screen, they will believe they have successfully penetrated the security measures and will likely stop trying to gain further access. Additional screens may be built into the system which will continue to present non-customized content if the unauthorized user attempts to further navigate from the initial non-customized screen. As the unauthorized user continues to be presented with non-customized content pages, the desire to find restricted content is thereby diminished. Activity logs may be maintained to determine and track attempts by unauthorized users to access the restricted content. In certain embodiments, a notification can be sent to the system administrator as soon as an unauthorized user attempts to access the system. In other embodiments, the log of unauthorized access attempts for a given time period may be periodically sent to the administrator.

At 212, the authenticated user is able to place an order for a particular product being displayed. In certain embodiments, the system 100 may be configured to require the user to enter additional security information, such as a username or password, in addition to payment information (i.e., credit card numbers) before actually placing an order. In other embodiments, the user may be allowed to order products without entering any additional information, wherein an invoice for payment may be sent directly to the employer. For example, the employer may have already agreed to provide payment for company shirts or uniforms bearing the company logo when ordered from employer computers.

At 214, the web server 102 optionally sends a request to a fulfillment system. In one example, the fulfillment system includes manufacturing server 103. The manufacturing server 103, in conjunction with machine control 105, initiates the automated production or retrieval of the product. In certain embodiments, the specifications for a particular user may be stored within the manufacturing server 103 prior to receiving the product order. For example, a user's shirt size, favorite color, or other product preference may be entered in the system to simplify the ordering process for the user and to more fully automate the manufacturing process.

In certain embodiments, the manufacturing server 103 operates machine control 105 to manufacture or customize the product in real time (i.e., add custom stitched logos on clothing, assemble an electronic device, manufacture a custom length golf club), thereby reducing inventory requirements. In other embodiments, the manufacturing server 103 and machine control 105 may operate distribution equipment to select a specific pre-manufactured item from a warehouse facility, after which it can be shipped to the customer. In another example, manufacturing server may be configured to create the customized object such as by cutting, milling, grinding, polishing, and/or 3D printing the customized object.

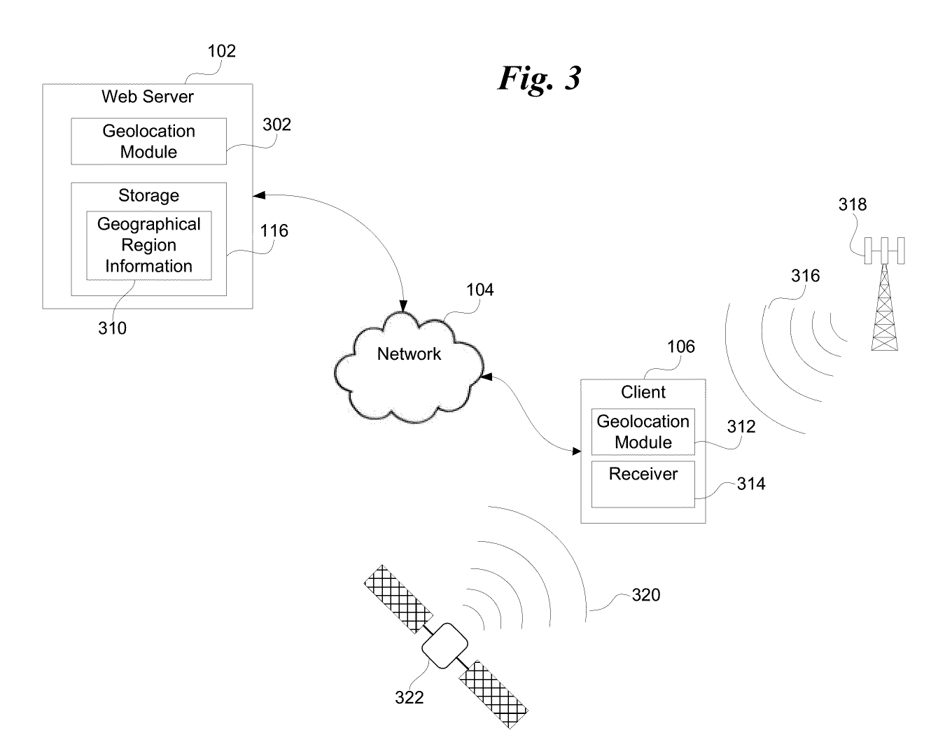

As mentioned above, the product and shopping customizations discussed herein may be associated with particular geographic region or regions which may be predefined regions. As illustrated in FIG. 3, Web server 102 and/or client 106 may be configured to geo-locate client 106 to determine whether a user is eligible to view authorized custom content. Geographical region information 310 may be compared with the geolocation of client 106 to determine if client 106 is inside an authorized geographical region. If so, authorized product information or other custom content may be sent by web server 102.

Web server 102 may include a geolocation module 302 which may configure the processor in web server 102 to determine the location of client 106. In one example, geolocation module 302 may determine a geographical location associated with IP address, Mac address, or other identifying information. Geolocation module 302 may also determine whether client 106 is within a geographical region defined by information 310 using location data passed to web server 102 by client 106. For example client 106 may operate software configured to determine the location of client 106 and pass this information to Web server 102 when a particular resource is requested. Information may be passed by any suitable means such as in an HTTP request header, as parameter values in the “GET” or “POST” portions of the HTTP request. For example, client 106 may send the latitude longitude associated with the geolocation of client computer 106 as parameter values in a “POST” request.

Client computer 106 may include a geolocation module 312 which may determine the location of client 106. For example, the geolocation system such as GPS system 322 may send electromagnetic signals 320 that may be received by receiver 314 and used by geolocation module 312 to determine the location of client 106. In another example, geolocation module 312 may use electromagnetic signals 316 sent from a cell tower 318 operating as part of a cellular network. Receiver 314 may be configured to receive signals 316 or 320 or both providing signaling information usable to generate positioning input from the various available geolocation systems to geolocation module 312. Geolocation module 312 may use the signal information to determine the location of client computer 106. Geolocation module 312 may identify the location of client computer 106 determining a physical location based on geographic location information associated with the IP address assigned to the client computer, the MAC address of the client computers network interface, RFID, Wi-Fi positioning system, device fingerprint, canvas fingerprinting, and the like.

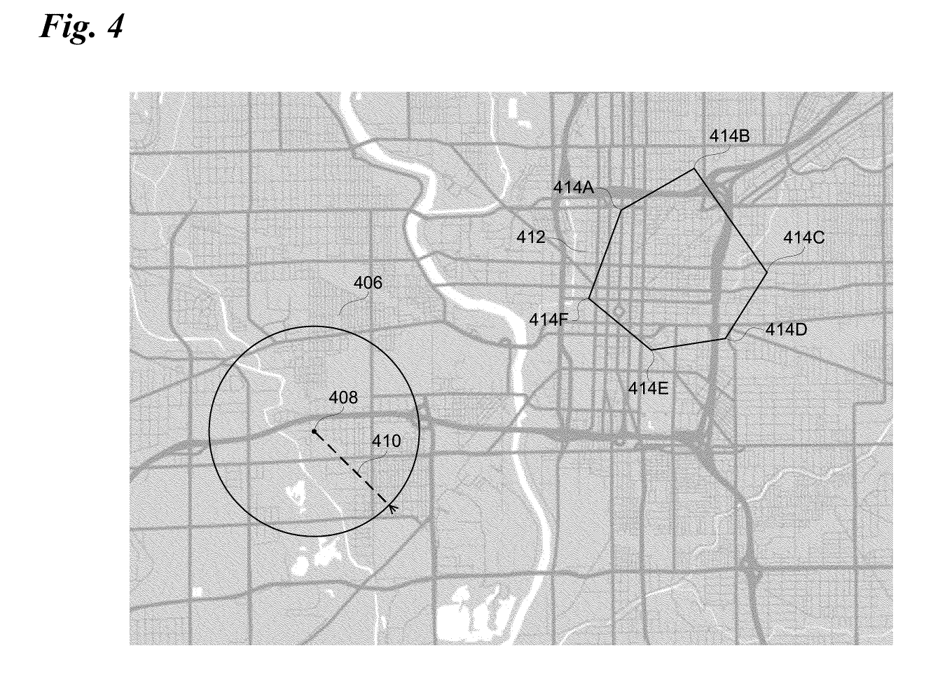

Some examples of geographical regions that may be represented in region information 310 are illustrated in FIG. 4. In one example, the geographical area associated with the products or other content shown to authorized users (i.e an “authorized content region”) has a boundary 412 defined by latitude/longitude coordinates illustrated in this example as coordinates 414A-414F. In this example, boundary 412 forms a closed polygon defined by vertices whose location is specified relative to actual locations by coordinates 414A-414F. These coordinates may be expressed as latitude/longitude pairs. This authorized product region may be compared with the location of client computer 106 as determined by geolocation software or hardware such as geolocation modules 312 or 302. Client computers 106 inside boundary 412 may be authorized to view customized content or other information while client computers 106 outside boundary 412 may view only “uncustomized” (i.e. “unauthorized”) product information.

In another example, the authorized product region has a boundary defined by a latitude/longitude coordinate, a street address, or other location 408 and a distance 410. In this example, a geolocation module like module 312 or module 302 may determine the location of client computer 106 and calculate the distance between the location of client computer 106 and location 408. Thus client computer 106 may be authorized to view customize product if it is less than distance 410 away from court at 408. In other words, location 408 and distance 410 define a substantially circular region 406.

FIG. 4 illustrates some examples of regions defined with respect to areas in a municipality. However, region information 310 may include regions defined with respect to any geographical area. Region information 310 may include or circumscribe a political boundary such as a county, province, state, country and the like. Region information may be defined to include other geographical areas such as a neighborhood, a sports venue, a conference center, a state park, a street and/or an area within a predefined distance from a street, or a congressional district, etc.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90, ” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“Antenna” or “Antenna system” generally refers to an electrical device, or series of devices, in any suitable configuration, that converts electric power into electromagnetic radiation. Such radiation may be either vertically, horizontally, or circularly polarized at any frequency along the electromagnetic spectrum. Antennas transmitting with circular polarity may have either right-handed or left-handed polarization.

In the case of radio waves, an antenna may transmit at frequencies ranging along electromagnetic spectrum from extremely low frequency (ELF) to extremely high frequency (EHF). An antenna or antenna system designed to transmit radio waves may comprise an arrangement of metallic conductors (elements), electrically connected (often through a transmission line) to a receiver or transmitter. An oscillating current of electrons forced through the antenna by a transmitter can create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming electromagnetic wave exert force on the electrons in the antenna elements, causing them to move back and forth, creating oscillating currents in the antenna. These currents can then be detected by receivers and processed to retrieve digital or analog signals or data.

Antennas can be designed to transmit and receive radio waves substantially equally in all horizontal directions (omnidirectional antennas), or preferentially in a particular direction (directional or high gain antennas). In the latter case, an antenna may also include additional elements or surfaces which may or may not have any physical electrical connection to the transmitter or receiver. For example, parasitic elements, parabolic reflectors or horns, and other such non-energized elements serve to direct the radio waves into a beam or other desired radiation pattern. Thus antennas may be configured to exhibit increased or decreased directionality or “gain” by the placement of these various surfaces or elements. High gain antennas can be configured to direct a substantially large portion of the radiated electromagnetic energy in a given direction that may be vertical horizontal or any combination thereof.

Antennas may also be configured to radiate electromagnetic energy within a specific range of vertical angles (i.e. “takeoff” angles) relative to the earth in order to focus electromagnetic energy toward an upper layer of the atmosphere such as the ionosphere. By directing electromagnetic energy toward the upper atmosphere at a specific angle, specific skip distances may be achieved at particular times of day by transmitting electromagnetic energy at particular frequencies.

Other examples of antennas include emitters and sensors that convert electrical energy into pulses of electromagnetic energy in the visible or invisible light portion of the electromagnetic spectrum. Examples include light emitting diodes, lasers, and the like that are configured to generate electromagnetic energy at frequencies ranging along the electromagnetic spectrum from far infrared to extreme ultraviolet.

“Battery” generally refers to an electrical energy storage device or storage system including multiple energy storage devices. A battery may include one or more separate electrochemical cells, each converting stored chemical energy into electrical energy by a chemical reaction to generate an electromotive force (or “EMF” measured in Volts). An individual battery cell may have a positive terminal (cathode) with a higher electrical potential, and a negative terminal (anode) that is at a lower electrical potential than the cathode. Any suitable electrochemical cell may be used that employ any suitable chemical process, including galvanic cells, electrolytic cells, fuel cells, flow cells and voltaic piles. When a battery is connected to an external circuit, electrolytes are able to move as ions within the battery, allowing the chemical reactions to be completed at the separate terminals thus delivering energy to the external circuit.

A battery may be a “primary” battery that can produce current immediately upon assembly. Examples of this type include alkaline batteries, nickel oxyhydroxide, lithium-copper, lithium-manganese, lithium-iron, lithium-carbon, lithium-thionyl chloride, mercury oxide, magnesium, zinc-air, zinc-chloride, or zinc-carbon batteries. Such batteries are often referred to as “disposable” insofar as they are generally not rechargeable and are discarded or recycled after discharge.

A battery may also be a “secondary” or “rechargeable” battery that can produce little or no current until charged. Examples of this type include lead-acid batteries, valve regulated lead-acid batteries, sealed gel-cell batteries, and various “dry cell” batteries such as nickel-cadmium (NiCd), nickel-zinc (NiZn), nickel metal hydride (NiMH), and lithium-ion (Li-ion) batteries.

“Camera” generally refers to an apparatus or assembly that records images of a viewing area or field-of-view on a medium or in a memory. The images may be still images comprising a single frame or snapshot of the viewing area, or a series of frames recorded over a period of time that may be displayed in sequence to create the appearance of a moving image. Any suitable media may be used to store, reproduce, record, or otherwise maintain the images.

“Cellular Device” generally refers to a device which sends or receives data, and/or sends or receives telephone calls using a cellular network. Cellular devices may thus be characterized as nodes in a communications link operating as an originating and/or final receiving node. A cellular device transmits to and receives from a cellular transceiver located in the cell (e.g. at a base unit or “cell tower.”) Radio waves are generally used to transfer signals to and from the cellular device on a frequency that is specific (but not necessarily unique) to each cell. A cellular device may include a computer with memory, processor, display device, input/output devices, and so forth, and thus may be used as, and referred to as, a personal computing device.

“Cellular Network” or “mobile network” generally refers to a communications link or communications network where the final communications link to an originating sending node or final receiving node in the network is via a wireless link. The cellular network is distributed over land areas (“cells”), each cell served by at least one fixed-location transceiver known as a cell site, base station, or generically, a “cell tower”. This base station provides the cell with the network coverage which can be used for transmission of voice, data and other types of communication. In a cellular network, each cell uses a different set of frequencies from neighboring cells, to avoid interference and provide guaranteed bandwidth within each cell.

In a cellular network, switching from one cell frequency to a different cell frequency is done electronically without interruption as various mobile devices with transceivers configured to communicate with the network (i.e. the originating or final receiver nodes) move from cell to cell during an ongoing continuous communication, all generally without a base station operator or manual switching. This is called the “handover” or “handoff.” Typically, a new channel is automatically selected for the mobile device on the new base station which will serve it as the mobile device moves around in the cell. The mobile unit then automatically switches from the current channel to the new channel and communication continues. The most common example of a cellular network is a mobile phone (cell phone) network.

“Client Computer” generally refers to a computer with hardware or software that accesses a service, resource, data, and the like that is made available by another computer, sometimes referred to as a server. The server is often (but not always) on another computer system, in which case the client accesses the service by way of a network sending information via a communications link between the client and the server. Client computers may be referred to as such because they may fulfill the “client” role in the “client-server model”.

A client computer may, for example, execute program code that is configured to send a request to another computer program (which may or may not be located on another computer). For example, a web browser operates as a client and connects to web servers to retrieve web pages, images, videos, audio, data, and the like. In another example, an e-mail client may retrieve email from mail servers.

“Communication Link” generally refers to a connection between two or more communicating entities and may or may not include a communications channel between the communicating entities. The communication between the communicating entities may occur by any suitable means. For example the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

In the case of a logical link, the communication link may be a conceptual linkage between the sender and recipient such as a transmission station in the receiving station. Logical link may include any combination of physical, electrical, electromagnetic, or other types of communication links.

“Communication node” generally refers to a physical or logical connection point, redistribution point or endpoint along a communication link. A physical network node is generally referred to as an active electronic device attached or coupled to a communication link, either physically, logically, or electromagnetically. A physical node is capable of sending, receiving, or forwarding information over a communication link. A communication node may or may not include a computer, processor, transmitter, receiver, repeater, and/or transmission lines, or any combination thereof.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository” , or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data). The DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Wash., USA; MySQL and various versions of the Oracle DBMS, often referred to as simply “Oracle” both separately offered by the Oracle Corporation of Redwood City, Calif., USA; the DBMS generally referred to as “SAP” provided by SAP SE of Walldorf, Germany; and the DB2 DBMS provided by the International Business Machines Corporation (IBM) of Armonk, N.Y., USA.

The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.

“Display device” generally refers to a device capable of being controlled by an electronic circuit or processor to display information in a visual or tactile. A display device may be configured as an input device taking input from a user or other system (e.g. a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, yellow, and green indicators configured to indicate a temperature range.

“Geolocation” or “Geopositioning” generally refers identifying the location of, or the location itself of, a “real-world” or “physical” geographic location or location of an object, such as a position on the globe, the position of a topographical feature, a building, a particular source of electromagnetic radiation, a mobile phone or an network-connected computer. Thus geolocation may be used as a verb referring to the practice of assessing the physical location, or in the noun form as the actual assessed location itself. In this usage, geolocation can refer to the latitude and longitude coordinates of a particular location as defined by ISO/IEC 19762-5:2008.Geolocation is closely related to the use of positioning systems such as the Global Positioning System (GPS), and may include determining a recognizable location coordinate (e.g. a street address) rather than just a set of geographic coordinates.

A geolocation/geopositioning module, engine, or device may use any suitable positioning system or positioning technology. For example a geolocation module may use radio frequency (RF) location methods, such as Multilateration or Time Difference Of Arrival (TDOA) to geolocate an object. GPS is an example of a TDOA geolocation system. TDOA systems often utilize mapping displays or other geographic information system. When a GPS signal is unavailable, geolocation modules may use cellular signal data associated with a mobile device obtained from cell towers to triangulate the approximate position of the mobile device, a method that may not be as accurate as GPS. This is in contrast to earlier radiolocation technologies, for example Direction Finding where a line of bearing to a transmitter is achieved as part of the process.

A geolocation module or engine may also rely on internet and computer geolocation that may be performed by associating a geographic location with the Internet Protocol (IP) address, MAC address, RFID, hardware embedded article/production number, embedded software number (such as UUID, Exif/IPTC/XMP or modern steganography), invoice, Wi-Fi positioning system, device fingerprint, canvas fingerprinting or device GPS coordinates, or other, perhaps self-disclosed information. Network geolocation may work by automatically looking up an IP address on a WHOIS service and retrieving the registrant's physical address.

IP address location data can include information such as country, region, city, postal/zip code, latitude, longitude and timezone. Deeper data sets can determine other parameters such as domain name, connection speed, ISP, language, proxies, company name, Designated Market Area (DMA), Metro Survey Areas (MSA), North American Industry Classification System (NAICS) codes, and home/business.

“Generate” as used herein generally refers to retrieval of pricing and/or product content with or without a real-time computation or determination of the prices and products to be displayed. For example, “generating” content may involve programmatically determining which one of multiple static web pages to return to a requesting client. In another example, generating content may involve executing code to create content that is specific (if not unique) to a particular user. This content creation may occur as the user waits, starting when the request is received and finishing before the resulting content is returned to the client computer.

“Input Device” generally refers to a device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Memory” generally refers to a storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAIVI), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Mobile phone” as used herein is a specific example of a cellular device and is synonymous with the terms “cell phone” or “smart phone” all of which refer to a portable telephone which receives or makes calls through a cell of a cellular network. Mobile phones may thus be characterized as nodes in a communications link operating as an originating and/or final receiving node. A cell phone transmits to and receives from a cellular transceiver located in the cell (e.g. at a base unit or “cell tower.”) Radio waves are generally used to transfer signals to and from the cell phone on a frequency that is specific (but not necessarily unique) to each cell. A mobile phone may be thought of, or may include, a computer, and may include memory, processor, display device, input/output devices, and so forth. A mobile phone may also be used as, and/or referred to as, a personal computing device.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eye glasses, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired communications link.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, Calif., USA. Other examples of commercially available processors include but are not limited to the X8 and Freescale Coldfire processors made by Motorola Corporation of Schaumburg, Ill., USA; the ARM processor and TEGRA System on a Chip (SoC) processors manufactured by Nvidia of Santa Clara, Calif., USA; the POWER 7 processor manufactured by International Business Machines of White Plains, N.Y., USA; any of the FX, Phenom, Athlon, Sempron, or Opteron processors manufactured by Advanced Micro Devices of Sunnyvale, Calif., USA; or the Snapdragon SoC processors manufactured by Qalcomm of San Diego, Calif., USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

“Receive” generally refers to accepting something transferred, communicated, conveyed, relayed, dispatched, or forwarded. The concept may or may not include the act of listening or waiting for something to arrive from a transmitting entity. For example, a transmission may be received without knowledge as to who or what transmitted it. Likewise the transmission may be sent with or without knowledge of who or what is receiving it. To “receive” may include, but is not limited to, the act of capturing or obtaining electromagnetic energy at any suitable frequency in the electromagnetic spectrum. Receiving may occur by sensing electromagnetic radiation. Sensing electromagnetic radiation may involve detecting energy waves moving through or from a medium such as a wire or optical fiber. Receiving includes receiving digital signals which may define various types of analog or binary data such as signals, datagrams, packets and the like.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then
{
    Prepare for rain;
} else {
    Prepare for sunshine;
}
```

“Receiver” generally refers to a device configured to receive, for example, digital or analog signals carrying information via electromagnetic energy. A receiver using electromagnetic energy may operate with an antenna or antenna system to intercept electromagnetic waves passing through a medium such as air, a conductor such as a metallic cable, or through glass fibers. A receiver can be a separate piece of electronic equipment, or an electrical circuit within another electronic device. A receiver and a transmitter combined in one unit are called a “transceiver”.

A receiver may use electronic circuits configured to filter or separate one or more desired radio frequency signals from all the other signals received by the antenna, an electronic amplifier to increase the power of the signal for further processing, and circuits configured to demodulate the information received.

Examples of the information received include sound (an audio signal), images (a video signal) or data (a digital signal). Devices that contain radio receivers include television sets, radar equipment, two-way radios, cell phones and other cellular devices, wireless computer networks, GPS navigation devices, radio telescopes, Bluetooth enabled devices, garage door openers, and/or baby monitors.

“Short Message Service (SMS)” generally refers to a text messaging service component of phone, Web, or mobile communication systems. It uses standardized communications protocols to allow fixed line or mobile phone devices to exchange short text messages. Transmission of short messages between a Short Message Service Center (SMSC) and personal computing device is done whenever using the Mobile Application Part (MAP) of the SS7 protocol. Messages payloads may be limited by the constraints of the signaling protocol to precisely 140 octets (140 octets*8 bits/octet=1120 bits). Short messages can be encoded using a variety of alphabets: the default GSM 7-bit alphabet, the 8-bit data alphabet, and the 16-bit UCS-2 alphabet. Depending on which alphabet the subscriber has configured in the handset, this leads to the maximum individual short message sizes of 160 7-bit characters, 140 8-bit characters, or 70 16-bit characters.

“Transmit” generally refers to causing something to be transferred, communicated, conveyed, relayed, dispatched, or forwarded. The concept may or may not include the act of conveying something from a transmitting entity to a receiving entity. For example, a transmission may be received without knowledge as to who or what transmitted it. Likewise the transmission may be sent with or without knowledge of who or what is receiving it. To “transmit” may include, but is not limited to, the act of sending or broadcasting electromagnetic energy at any suitable frequency in the electromagnetic spectrum. Transmissions may include digital signals which may define various types of binary data such as datagrams, packets and the like. A transmission may also include analog signals.

Information such as a signal provided to the transmitter may be encoded or modulated by the transmitter using various digital or analog circuits. The information may then be transmitted. Examples of such information include sound (an audio signal), images (a video signal) or data (a digital signal). Devices that contain radio transmitters include radar equipment, two-way radios, cell phones and other cellular devices, wireless computer networks and network devices, GPS navigation devices, radio telescopes, Radio Frequency Identification (RFID) chips, Bluetooth enabled devices, and garage door openers.

“Transmitter” generally refers to a device configured to transmit, for example, digital or analog signals carrying information via electromagnetic energy. A transmitter using electromagnetic energy may operate with an antenna or antenna system to produce electromagnetic waves passing through a medium such as air, a conductor such as a metallic cable, or through glass fibers. A transmitter can be a separate piece of electronic equipment, or an electrical circuit within another electronic device. A transmitter and a receiver combined in one unit are called a “transceiver”.

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

What is claimed is:

1. A method comprising:
using a server computer having a processor, receiving an HTTP request from a remote client computer over a network, the HTTP request including a request header containing a referring IP address;
using either the server computer or the remote client computer to determine a location of the remote client computer using positioning input from a geolocation system;
determining if a user is authorized to access a first product information using the server computer, wherein the server computer uses the processor to evaluate the referring IP address and the location of the remote client computer;
in response to determining that the user is authorized, using the server computer, transmitting a first product information to the remote client computer using the network; and
in response to determining that the user is not authorized, using the server computer, transmitting a second product information to the remote client computer using the network.

2. The method of claim 1, wherein the server computer is configured to determine if the user is an authorized user without accepting any identification information manually entered by the user.

3. The method of claim 1, wherein determining the location of the remote client computer includes receiving the positioning input from a remote transmitter transmitting a signal received by a receiver in the remote client computer, and wherein the remote client computer includes a geolocation module configured to determine the location of the remote client computer based on the signals received by the receiver.

4. The method of claim 1, wherein the geolocation system includes a Global Positioning System (GPS), and wherein the remote client computer determines its location using a geolocation module accepting input from the geolocation system.

5. The method of claim 1, wherein the geolocation system includes one or more cell towers and cellular signal data associated with the remote client computer, and wherein the remote client computer determines its location using a geolocation module using the cellular signal data.

6. The method of claim 1, wherein evaluating the location of the remote client computer includes determining that the location of the remote client computer is within a predefined region defined by a closed polygon having three or more vertices, the three or more vertices each defined by latitude/longitude coordinates.

7. The method of claim 1, wherein evaluating the location of the remote client computer includes determining that the location of the remote client computer is within a predefined region that is substantially circular and defined by a central coordinate, and a distance from the central coordinate.

8. The method of claim 1, evaluating the location to determine if the user is authorized includes:
determining a physical location associated with the referring IP address; and
determining whether the physical location associated with the referring IP address is inside or outside an authorized geographical region.

9. The method of claim 1, wherein evaluating the location of the remote client computer includes determining that the location of the remote client computer is within a predefined region with a boundary defined by a street address and a distance from the street address.

10. The method of claim 1, where the first product information comprises selective pricing discounts for users that are authorized that are not available to users who are not authorized.

11. The method of claim 1, wherein the HTTP request contains a referring URL, and wherein determining if a user is authorized to access the first product information includes evaluating the referring URL to determine if the user is authorized.

12. The method of claim 1, wherein the HTTP request contains an email domain, and wherein determining if a user is authorized to access the first product information includes evaluating the email domain to determine if the user is authorized.

13. The method of claim 1, wherein the HTTP request contains an embedded promotion code, and wherein determining if the user is authorized to access the first product information includes evaluating the embedded promotion code to determine if the user is authorized.

14. A method comprising:
using a server computer having a processor, receiving an HTTP request from a remote client computer over a network, the HTTP request including a request header containing a referring IP address;
determining a present location of the remote client computer using a server computer or the remote client computer;
determining if a user is within a geographical area associated with a first product information using a geolocation module in the server computer and/or the remote client computer;
determining if the referring IP address is an authorized IP address by comparing at least a portion of the referring IP address to one or more referring IP address rules associated with the first product information using the server computer and/or the remote client computer;
determining the user is authorized to access the first product information when the user is within the geographical area associated with the first product information, and the referring IP address is an authorized IP address;
transmitting the first product information to the remote client computer using the network when the user is authorized to access the first product information;
determining the user is not authorized to access the first product information when the user is not within the geographical area associated with the first product information, or the referring IP address is not an authorized IP address; and
transmitting a second product information to the remote client computer using the network when the user is not authorized to access the first product information.

15. The method of claim 14, wherein the determining if the user is an authorized user does not include evaluating identification information manually entered by the user.

16. The method of claim 14, wherein determining if the user is within a geographical area associated with a first product includes receiving positioning input from a remote transmitter transmitting a signal received by a receiver in the remote client computer, and wherein the remote client computer includes a geolocation module configured to determine the present location of the remote client computer using signals received by the receiver.

17. The method of claim 14, wherein the geolocation module determines the present location of the remote client computer using the processor in the remote client computer to process input received from a Global Positioning System (GPS).

18. The method of claim 14, wherein the geolocation module determines the present location of the remote client computer using the processor in the remote client computer to process cellular signal data associated with the remote client computer.

19. The method of claim 14, wherein the geographical area associated with the first product has a boundary defined by three or more latitude/longitude coordinates.

20. The method of claim 14, wherein the geographical area associated with the first product has a boundary defined by a latitude/longitude coordinate and a distance from the latitude/longitude coordinate.

21. The method of claim 14, wherein determining the present location of the remote client computer includes determining a location associated with the referring IP address.

22. The method of claim 14, wherein the geographical area associated with the first product has a boundary defined by a street address and a distance from the street address.

23. The method of claim 14, where the first product information comprises selective pricing discounts for users that are authorized that are not available to users who are not authorized.

24. The method of claim 14,
wherein determining the user is authorized to access the first product information includes determining that a referring URL sent in the HTTP request is an authorized referring URL by comparing at least a portion of the referring URL to one or more referring URL rules associated with the first product information using the server computer; and
wherein determining the user is not authorized to access the first product information includes determining that the referring URL is not an authorized referring URL by comparing at least a portion of the referring URL to the one or more referring URL rules associated with the first product information using the server computer.

25. The method of claim 14,
wherein determining the user is authorized to access the first product information includes determining that an embedded promotion code sent in the HTTP request is an authorized promotion code using the server computer; and
wherein determining the user is not authorized to access the first product information includes determining that the embedded promotion code is not an authorized promotion code using the server computer.

26. A computer-implemented method for providing customized online content, comprising:
using a server computer having a processor, receiving an HTTP request from a remote user computer over a network, said HTTP request including one or more request headers containing at least one of a referring IP address and an email domain;
evaluating, with the processor a location of the user computer, and at least one of the referring IP address and the email domain from said one or more request headers in said HTTP request to determine if a user is authorized for access to the customized online content;
in response to determining that the user is authorized for access, using the server computer, transmitting a first product information to the remote user computer over the network, the first product information based on at least one of the referring IP address, and the email domain; and
in response to determining that the user is not authorized, using the server computer, transmitting a second product information to the remote user computer over the network;
wherein an authorized user is not required to manually enter any identification information before gaining access to the customized online content.

27. The method of claim 26, wherein said first product information is customized based on at least one of the referring IP address and the email domain; and
wherein said second product information is not customized.

28. The method of claim 26, wherein the request headers include a request header containing a referring URL, and wherein both the referring IP address and the referring URL are evaluated to determine if the user is authorized for access.

29. The method of claim 26, wherein said evaluating step further comprises:
determining a physical location associated with said referring IP address; and
using said physical location as a factor in determining whether said user is authorized for access.

30. The method of claim 26, further comprising the steps of:
receiving a request from the user for a product listed in said customized online content; and
manufacturing the product in response to receiving said request.

31. The method of claim 30, wherein the product is manufactured according to specifications based on at least one of the referring IP address and the email domain.

32. The method of claim 26, wherein an unauthorized user is presented with a plurality of successive interface screens containing non-customized product information.

33. The method of claim 27,
wherein the request headers further contain a user identifier; and
wherein said first product information is further customized based on the user identifier.

34. The method of claim 33, wherein said user identifier is retrieved from an LDAP directory.

35. The method of claim 26, where said first product information comprises selective pricing discounts based on at least one of the referring IP address and the email domain.

36. The method of claim 26, wherein said first product information comprises selected product models based on at least one of the referring IP address and the email domain
